(19) United States
(12) Patent Application Publication
(10) Pub. No.: US 2008/0095992 A1
(43) Pub. Date: Apr. 24, 2008

(54) Decorated Injection-Moulded Article, Transfer Film, And Method For Producing One Such Article

(76) Inventors: Andreas Hirschfelder, Furth (DE); Klaus Hong, Cadolzburg (DE)

Correspondence Address: Charles R. Hoffmann;Hoffmann & Baron, 6900 Jericho Turnpike, Syosset, NY, 11791, US

(21) Appl. No.: 11/661,025

(22) PCT Filed: Aug. 23, 2005
(86) PCT No.: PCT/DE05/01487

§ 371 Date: May 25, 2007

(30) Foreign Application Priority Data
Aug. 27, 2004 (DE) 10 2004 041 867.5

(51) Int. Cl. B29C 45/14; B32B 7/00

(52) U.S. Cl. 428/200; 264/1.7; 264/104; 264/132; 264/232; 264/279.1; 428/914

(57) ABSTRACT

The invention concerns a decorated injection molded article which is formed from at least one injected plastic material and at least one decorative element mechanically fixedly connected thereto, wherein the decorative element has one or more layer portions and provides a decoration and/or a protective layer for the injection molded article, wherein the injection molded article has at least one injection molded seam which is formed on the injected plastic material in the injection molding operation in the closing region of an injection molding mold or in the transitional region between at least two individual parts of the injection molding mold, and wherein the at least one decorative element only partially covers a surface region of the plastic material defined by an injection molded seam extending in an annular configuration on the plastic material and the decorative element has at least one protective lacquer layer and/or at least one decorative layer and adjoining the protective lacquer or decorative layer at least one priming layer which softens at an injection molding temperature for the plastic material, wherein the priming layer is bonded to the plastic material. The invention further concerns an inmold-capable transfer film as well as a process for the production of such injection molded articles.

The invention concerns a decorated injection molded article which is formed from at least one injected plastic material and at least one decorative element mechanically fixedly connected thereto, wherein the decorative element has one or more layer portions and provides a decoration and/or a protective layer for the injection molded article and wherein the injection molded article has at least one injection molded seam which is formed on the injected plastic material in the injection molding operation in the closing region of an injection molding mold or in the transitional region between at least two individual parts of the injection molding mold.

The invention further concerns a transfer film for the production of such a decorated injection molded article, wherein the transfer film has at least a carrier film, a release layer arranged on the carrier film and a transfer layer means arranged on the side of the release layer remote from the carrier film, as a decorative element, wherein the decorative element has one or more layer portions and provides a decoration and/or a protective layer for the injection molded article, wherein the transfer layer means adjoining the release layer has at least one protective lacquer layer and/or at least one decorative layer and adjoining the protective lacquer or decorative layer on the side of the transfer film remote from the carrier film at least one adhesive layer which softens at an injection molding temperature and bonds to a plastic injection material to form the injection molded article.

The invention further concerns a process for the production of a decorated injection molded article using a transfer film has at least a carrier film, a release layer arranged on the carrier film and a transfer layer means arranged on the side of the release layer remote from the carrier film, as a decorative element, wherein the decorative element has one or more layer portions and provides a decoration and/or a protective layer for the injection molded article, wherein the transfer layer means adjoining the release layer has at least one protective lacquer layer and/or at least one decorative layer and adjoining the protective lacquer or decorative layer on the side of the transfer film remote from the carrier film at least one priming layer, wherein the transfer film is arranged in an opened injection molding mold comprising at least two individual parts, the injection molding mold is closed and filled with plastic injection material, wherein the priming layer softens at an injection temperature and bonds to the plastic injection material and wherein formed on the injection molded article is at least one injection molded seam which is formed in the closure region of the injection molding mold or in the transitional region between the at least two individual parts of the injection molding mold, wherein the plastic injection material is hardened to provide a solid plastic material. Decoration processes of that kind for injection molded articles are usually referred to as inmold decoration processes or IMD injection molding processes.

Decorated injection molded articles, processes for the production thereof and inmold-capable transfer films or IMD films are known per se. Thus DE 102 21 482 C1 discloses an apparatus for the production of a molding comprising a hardening injection molding material which is decorated by inmold injection with a stamping film comprising a carrier film and a decorative layer. In that case the stamping film is introduced into the opened injection molding tool, the decorative layer of the stamping film facing towards an upper part of the mold. The injection molding mold is closed and liquid injection molding material is injected into the injection molding mold cavity through an injection passage, in which case the stamping film is caused to adhere closely to the visible side of the injection molded part. In that situation the stamping film is joined to the injection molding material which after hardening is removed from the injection molding mold. After the carrier film is pulled off the decorative layer the decorated molding is finished. Injection molded articles which are decorated in that way are used in particular in relation to internal parts of motor vehicles such as door strips, strips in instrument panels, shift lever covers, central console covers and in relation to external parts of motor vehicles such as door ram guard strips, covers on A, B and C pillars and in the audio and video fields in relation to decorative strips on the casings of radios and televisions.

DE 102 36 810 A1 discloses partially structured multi-layered films which are suitable for use in injection molding molds. Such an IMD-capable multi-layer film or a multi-layer film for inmold decoration of injection molded parts comprises a carrier film with a decorative element for transfer onto the injection molded part. The carrier film is removed after the decorative element has been applied to the injection molded body. The decorative element has a release layer, a protective lacquer layer, a structure layer with a spatial structure, an intermediate layer, a reflection layer and an adhesive layer. The release layer serves in that respect for releasing the decorative element from the carrier and can comprise for example a wax-like material.

As disclosed by JP 62128720 A, IMD films are usually guided between a fixed and a movable part of the injection molding mold by way of a film advance device. In the case of individual image representations in the region of the decorative film which is to be applied by lamination, the IMD film is also positioned in the correct position relative to the injection molding mold by way of sensors and position markings on the IMD film before the injection molding mold is closed and the hot plastic injection material is injected behind the IMD film.

Hitherto, due to the manufacturing procedure involved, injection molded articles decorated with a decorative element in an inmold process involve complete coverage with the decorative element of a surface region which is defined by an injection molded seam extending in a ring configuration on the plastic material. Such a surface region generally predominantly also forms the visible surface of the injection molded article so that this involves decoration over the entire area thereof of the complete visible surface. Accordingly the optical appearance of the injection molded article is hitherto dependent on the decorative element used.

Now, the object of the invention is to afford injection molded articles decorated with decorative elements and having a novel optical appearance, as well as an improvement in their subsequent further processability. The invention further seeks to provide a transfer film suitable for forming such decorated injection molded articles as well as a suitable process for the production of such decorated injection molded articles.

For the decorated injection molded article which is formed from at least one injected plastic material and at least one decorative element mechanically fixedly connected thereto, wherein the decorative element has one or more layer portions and provides a decoration and/or a protective layer for the injection molded article and wherein the injection molded article has at least one injection molded seam which is formed on the injected plastic material in the injection molding operation in the closing region of an injection molding mold or in the transitional region between at least two individual parts of the injection molding mold, that object is attained in that the at least one decorative element only partially covers a surface region of the plastic material defined by an injection molded seam extending in an annular configuration on the plastic material and that the decorative element has at least one protective lacquer layer and/or at least one decorative layer and adjoining the protective lacquer or decorative layer at least one priming layer which softens at an injection molding temperature for the plastic material, wherein the priming layer is bonded to the plastic material.

In a surface region defined by an injection molded seam extending in an annular configuration on the plastic material, the injection molded article as set forth in the invention has only partial coating with the decorative element so that, in the visible region, beside the region or regions decorated with the decorative element of the injection molded article, there are there also regions with hardened plastic injection material without being covered by a decorative element. That opens up a large number of new possible ways of providing a visually attractive, decorated injection molded article. If moreover attractive color configuration of the plastic injection material is considered, that affords further new optical effects. Thus for example it is possible to provide injection molded articles for the automobile sector, which have a marquetry decoration. In that respect the marquetry or the marquetry effect are produced by partially provided decorative elements. In addition, the exposed regions of the hardened plastic injection material provide that further processing of the injection molded article is enormously simplified, as will be further described hereinafter.

It is particularly preferred if the at least one decorative element is superimposed on a three-dimensional surface structuring of the plastic material. In that case the three-dimensional structure can only be visible through the decorative element, but it can also be detected by touch in the region of the decorative element. That makes it possible to produce particularly attractive visual effects.

It is further preferred if the at least one decorative element on its side remote from the first plastic material is at least partially over-injected with a second plastic material. In that respect further optical effects can be produced, for achieving an optical depth, such as for example lens effects. However, injecting plastic material over the decorative element just for protecting it from mechanical loading and/or corrosive attack has also proven its worth.

Further optically attractive effects can be achieved if on its side remote from the at least one decorative element the second plastic material is at least partially covered with at least one further decorative element. In that respect the decorative elements can be optically superimposed so that for example specific depth effects or color effects are attained.

For a transfer film for the production of such a decorated injection molded article, wherein the transfer film has at least a carrier film, a release layer arranged on the carrier film and a transfer layer means arranged on the side of the release layer remote from the carrier film, as a decorative element, wherein the decorative element has one or more layer portions and provides a decoration and/or a protective layer for the injection molded article, wherein the transfer layer means adjoining the release layer has at least one protective lacquer layer and/or at least one decorative layer and adjoining the protective lacquer or decorative layer on the side of the transfer film remote from the carrier film at least one priming layer which softens at an injection molding temperature and bonds to the plastic injection material to form the injection molded article, that object is attained in that

a) a masking layer only partially covers the priming layer on its side remote from the carrier film, wherein the masking layer is such that it does not bond to the plastic material under injection conditions, or

b) the priming layer is only arranged region-wise and the protective lacquer or decorative layer adjoining the priming layer is such that it does not bond to the plastic material under injection conditions, or

c) the transfer layer is only arranged region-wise on the release layer and the release layer is such that it does not bond to the plastic material under injection conditions.

The fact that the respective layers in cases a), b) and c) are not bonded to the plastic material makes it possible for injection molded articles to be partially decorated at their surface in a simple and inexpensive fashion.

Suitable layers which prevent adhesion or bonding to the plastic injection material preferably have a softening temperature which is markedly above the processing temperature in the injection molding tool. It is particularly preferred in that respect if in case a) the masking layer, in case b) the protective lacquer or decorative layer adjoining the priming layer and in case c) the release layer withstands an injection temperature for the plastic material without softening. That means that bonding to the injected plastic material is made greatly more difficult.

It is further advantageous if in case a) the masking layer, in case b) the protective lacquer or decorative layer adjoining the priming layer and in case c) the release layer is chemically incompatible with the plastic material so that repulsion already occurs at a molecular level, to prevent bonding to the injected plastic material.

In contrast layers of the transfer film which are to be mechanically firmly bonded to the plastic material preferably soften at least partially under the processing temperatures in the injection molding mold and have at least slight compatibility with the molten plastic material.

It has proven appropriate if in case a) the masking layer, in case b) the protective lacquer or decorative layer adjoining the priming layer and in case c) the release layer is a lacquer layer which is highly cross-linked by radiation hardening, isocyanate hardening or acid hardening. Lacquer layers which are highly cross-linked by radiation hardening, isocyanate hardening or acid hardening do not bond to a hot plastic injection material and therefore permit easy and defined separation from the injection molded body.

For example acid-hardened melamine resin lacquer, 2-component polyurethanes or radiation-hardened lacquer have proven their worth as the masking layer.

The release or separation action of such a layer can be further enhanced if for example lacquers are used, which have a very uniform layer thickness in the region of 0.1-20 μm, preferably 0.3-2.5 μm, and have a smooth surface with a surface roughness in order as far as possible to prevent mechanical interlocking with the plastic injection material. It is also advantageous if those lacquer layers have a low surface tension. The surface tension of the masking layer can be further reduced by suitable additives, preferably wax-based, fluorohydrocarbon-based or silicone-based additives so that the separation action thereof is further enhanced. Suitable substances here are in particular hydroxyfunctional polyether-modified polysiloxanes, dispersions of polyethylene waxes with a melting range below 130° C. and functionalized fluoroethylene mixed polymers (hydroxy number: 55 mg KOH/g).

In order to avoid as completely as possible contamination of the plastic injection material by the masking layer, it has proven advantageous if the additive is anchored by chemical reactions in the polymer network of the masking layer.

For the process for the production of a decorated injection molded article using a transfer film which has at least a carrier film, a release layer arranged on the carrier film and a transfer layer means arranged on the side of the release layer remote from the carrier film, as a decorative element, wherein the decorative element has one or more layer portions and provides a decoration and/or a protective layer for the injection molded article, wherein the transfer layer means adjoining the release layer has at least one protective lacquer layer and/or at least one decorative layer and adjoining the protective lacquer or decorative layer on the side of the transfer film remote from the carrier film at least one priming layer, wherein the transfer film is arranged in an opened injection molding mold comprising at least two individual parts, the injection molding mold is closed and filled with plastic injection material wherein the priming layer softens at an injection temperature and bonds to the plastic injection material and wherein formed on the injection molded article is at least one injection molded seam which is formed in the closure region of the injection molding mold or in the transitional region between the at least two individual parts of the injection molding mold, and wherein the plastic injection material is hardened to provide a first plastic material, that object is attained in that the at least one decorative element is transferred onto a surface region of the plastic material defined by an injection molded seam extending in an annular configuration on the plastic material, in such a way that the at least one decorative element only partially covers the surface region. Such a process permits the production of injection moldings according to the invention, which are only region-wise decorated and thus give rise to particular visual impressions on the part of viewers. Thus for example the viewer can be induced to think that there is marquetry here.

It has proven to be advantageous for the process according to the invention if a transfer film according to the invention is used, which is arranged in the injection molding mold in such a way that the carrier film bears directly against the injection molding mold. When the plastic injection material is injected into the injection molding mold the transfer film is pressed against the inside wall of the injection molding mold.

The layers disposed on the carrier film which is preferably of a thickness in the region of between 19 and 100 μm are preferably produced by intaglio printing, screen printing or, in particular the decorative layers, also by digital, flexo or offset printing.

If a transfer film in accordance with case a) is used the hot plastic injection material comes into contact with the masking layer and exposed regions of the priming layer. The plastic injection material is mechanically firmly bonded in the direct contact region to the priming layer, in which case the priming layer at least starts to melt or melts completely. No bonding occurs in the direct contact region between the masking layer and the plastic injection material as the masking layer does not bond to the plastic material, preferably, insofar as it does not soften or it softens only above the injection temperature, and there is no chemical reaction with the plastic injection material in the region of the injection temperature. After cooling of the plastic injection material the injection molding mold is opened and the carrier film is removed. In that situation, only the regions of the decorative element which are mechanically fixedly joined to the plastic material by way of the priming layer remain on the hardened plastic injection material. The regions of the decorative element which were covered by means of the masking layer are removed together with the carrier film and the masking layer so that the result is a decorated injection molded article in accordance with the invention. The use of a transfer film in accordance with case a) is particularly inexpensive as it is possible to use a conventional, IMD-capable transfer film which is only provided with a masking layer in the desired pattern or decoration. That means that a change in pattern can also be implemented easily, inexpensively and quickly.

It has proven advantageous if the masking layer is of a thickness in the region of between 1 and 4 μm. With such a layer thickness, particularly sharp edges and good transfer results are achieved for the decorative elements which are transferred in region-wise manner.

In order to guarantee reliable transfer of the transfer layer of the transfer film in case a), it is preferred if the masking layer has at least one opening of a diameter of at least 0.15 mm. Smaller diameters lead to incomplete transfer of transfer layer regions, with untidy, randomly varying edges, as the hot plastic injection material cannot penetrate through the opening or can only limitedly penetrate through the opening and bond to the priming layer.

If a transfer film in accordance with case b) is used, the hot plastic injection material comes into contact with the partially arranged priming layer and with the regions of a protective lacquer or decorative layer, which are uncovered by the priming layer. The hot plastic injection material mechanically fixedly bonds in the direct contact region to the priming layer, in which case the priming layer at least starts to melt or melts completely. No bonding occurs in the direct contact region between the protective lacquer or decorative layer and the plastic injection material as the protective lacquer or decorative layer does not bond to the plastic material, preferably insofar as it does not soften or it softens only above the injection temperature and there is also no chemical reaction with the plastic injection material in the region of the injection temperature. In that respect, the materials which can be used for the protective lacquer or decorative layer adjoining the priming layer can be those which are also suitable for the masking layer of case a), for example UV lacquer on a polyacrylate base or 2-component polyurethane lacquer. After cooling of the plastic injection material the injection molding mold is opened and the carrier film is removed. In that case only the regions of the decorative element which are mechanically fixedly joined to the plastic material by way of the priming layer remain on the hardened plastic injection material. The regions of the protective lacquer or decorative layer or layers which were uncovered by the priming layer are removed together with the carrier film so that the result is a decorated injection molded article in accordance with the invention. The use of a transfer film in accordance with case b) is also inexpensive as it is possible to use a conventional IMD-capable transfer film which is only provided with a priming layer in the desired pattern or decoration. That means that in this case also a change in pattern can be effected easily, inexpensively and quickly.

If a carrier film in accordance with case c) is used the hot plastic injection material comes into contact with the priming layer of the partially provided transfer layer as well as the exposed regions of a release layer which can also be produced over a surface of a carrier film of suitable material. The hot plastic injection material is mechanically fixedly bonded in the direct contact region to the priming layer, in which case the priming layer at least starts to melt or melts completely. No bonding occurs in the direct contact region between the release layer and the plastic injection material, preferably insofar as the release layer does not soften or softens only above the injection temperature and there is also no chemical reaction with the plastic injection material in the region of the injection temperature. In that respect the materials which can be used for the release layer can be those which are also suitable for the masking layer in accordance with case a), for example acid-hardened melamine resin lacquer, 2-component polyurethanes or radiation-hardened lacquer. After cooling of the plastic injection material the injection molding mold is opened and the carrier film is removed. In that case the decorative elements which are respectively mechanically fixedly joined to the plastic material by way of the priming layer remain on the hardened plastic injection material. The release layer is removed together with the carrier film so that the result obtained is a decorated injection molded article in accordance with the invention. The use of a transfer film in accordance with case c) is somewhat more expensive as the protective lacquer and decorative layers as well as the priming layer must be formed one above the other in register relationship. That means that a change in pattern here is somewhat more time-consuming than when using the transfer films of case a) or b).

Preferably in case a) the masking layer, in case b) the priming layer and in case c) the transfer layer are of a patterned configuration so that the result is patterned decoration of the injection molded article. In that respect the masking layer represents the negative for the pattern while in case b) the priming layer and in case c) the transfer layer represent the positive for the pattern. In that respect the term pattern is used to denote regular or irregular patterns, alphanumeric character representations or image representations such as coats of arms, logos, nature motifs or the like.

For the transfer film according to the invention, it has proven advantageous if the decorative layer includes an at least partially provided metal layer and/or an at least partially provided interference layer and/or an at least partially provided color layer and/or an at least partially arranged layer with relief structures such as macroscopic relief structures, diffractive structures or holograms, and/or a pigmented layer which has fluorescent or phosphorescent pigments or pigments with viewing angle-dependent color change effects.

For the protective lacquer layer of the transfer film according to the invention it has proven advantageous if the protective lacquer layer is colorlessly transparent, colored transparent or at least region-wise opaque. Further optical effects can be achieved in that way.

If the carrier film is formed from a material which can be readily released from the transfer layer after the injection molding operation, the transfer film has a surface which itself forms the release layer. The carrier film and the release layer thus form a unit. In that case it is possible to dispense with an additional release layer on the carrier film.

As already mentioned hereinbefore, further processing of the injection molded article is enormously simplified by virtue of the exposed regions of the hardened plastic injection material. Thus exposed regions of the hardened plastic injection material can be lacquered in a simple fashion without having to take account of the decorative film. In that respect the lacquer used only has to be matched to the material of the plastic injection material employed. More specifically, when the visible surface of the injection molded article was covered with the decorative film over the entire surface area, it was hitherto necessary for the lacquer for lacquering given regions of the injection molded article to be matched to the respective uppermost layer of the decorative film used. In the worst-case scenario that meant that a plurality of lacquer layers had to be produced on the uppermost layer of the decorative film in order to achieve the desired lacquering result.

Furthermore, it is now possible in a simple and uncomplicated fashion for a region of the injection molded article according to the invention, in which the hardened plastic injection material is not covered by the decorative film, to be glued, pressed or welded to further structural units, for example by means of laser radiation or ultrasound. In that respect, it is only necessary to heed matching of the process parameters of the joining process adopted, to the hardened plastic injection material of the injection molded article and the counterpart components which are to be joined thereto, without however heeding the decorative film used which frequently can only be exposed to lower temperatures or lower mechanical stresses than the hardened plastic injection material.

The injection molded article according to the invention is also found to be advantageous if a second plastic injection material is to be injected thereover in a further injection molding mold in order for example to produce lens-like elements. In that case it is usually possible to afford a good durable join between the hardened plastic material and the second plastic injection material. In principle the same or different plastic materials can be employed for the hardened plastic material and for the second plastic injection material, in which respect the reference to the same materials also denotes those which only involve different coloration of the plastic which is otherwise the same. In that respect the structure of the decorative film is advantageously not of significance.

Such an exposed region of the hardened plastic injection material can also be labeled or written upon without complication in the visible region of the injection molded article, for example by means of a laser. There is also the possibility that any optical lens systems arranged on the injection molded article or contact surfaces of electrically conducting contact structures incorporated into the plastic injection molded body remain uncovered by the decorative film so that they remain directly visible and accessible or in the case of contact surfaces so that they can be connected to electrical cables or electrical components. Therefore, it is no longer necessary to take any account of the decorative film so that in general terms this permits the injection molded article according to the invention to be further processed in a highly uncomplicated, fast and therefore inexpensive manner.

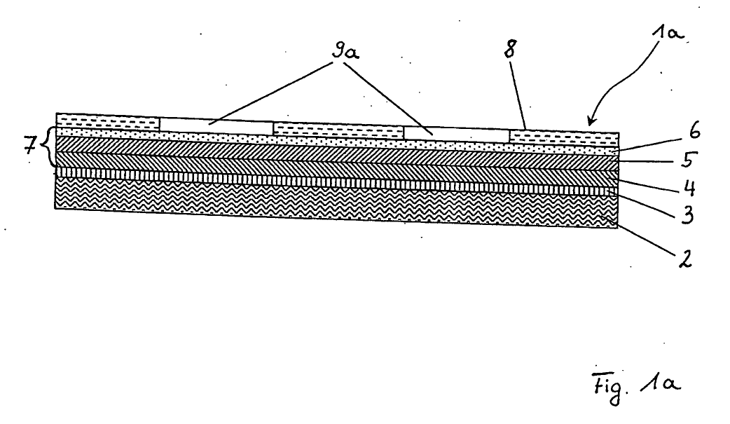

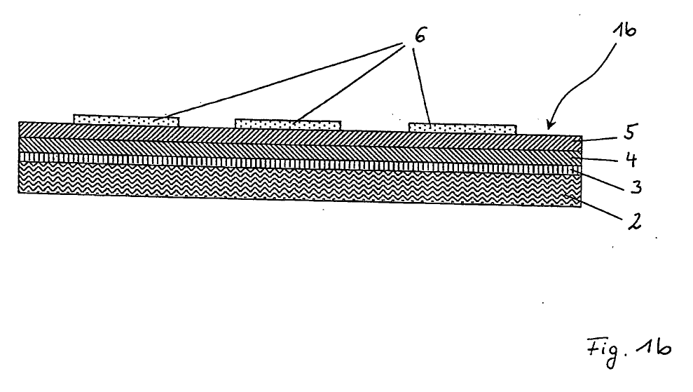

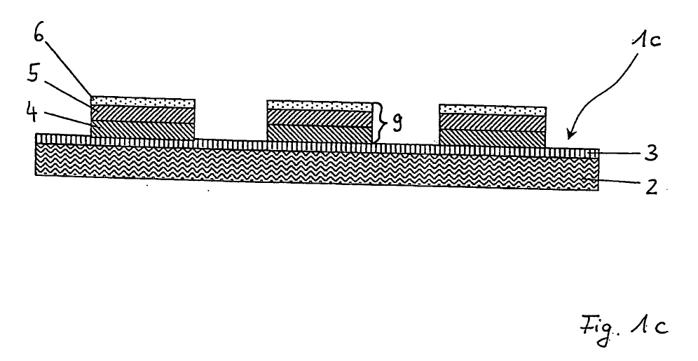

FIGS. 1a through 3a are intended to describe the invention by way of example. In the Figures:

FIG. 1a shows a cross-section through a transfer film in accordance with case a),

FIG. 1b shows a cross-section through a transfer film in accordance with case b),

FIG. 1c shows a cross-section through a transfer film in accordance with case c),

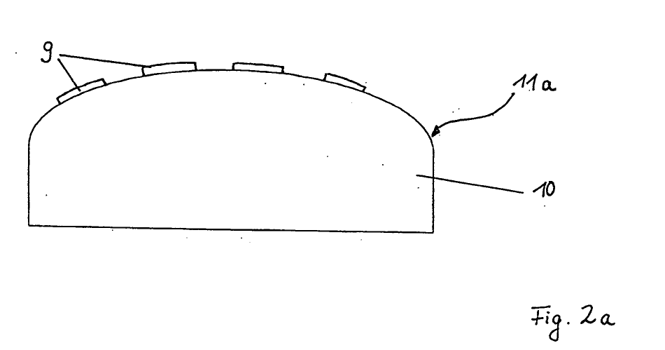

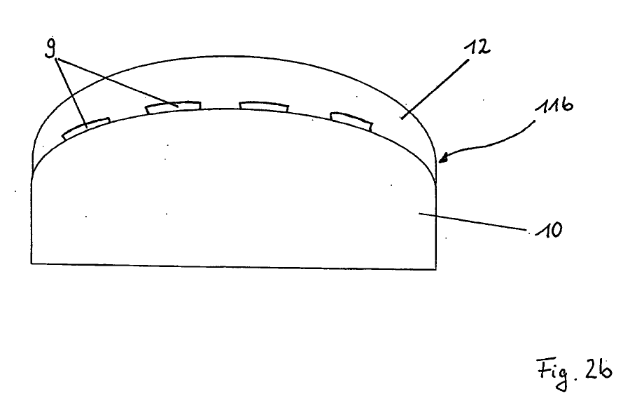

FIG. 2a shows a cross-section through a decorated injection molded article,

FIG. 2b shows a cross-section through a decorated injection molded article, with a second plastic material injected thereover in the visible region,

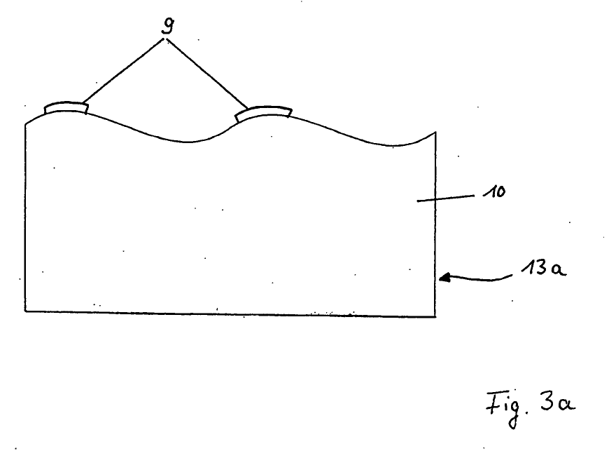

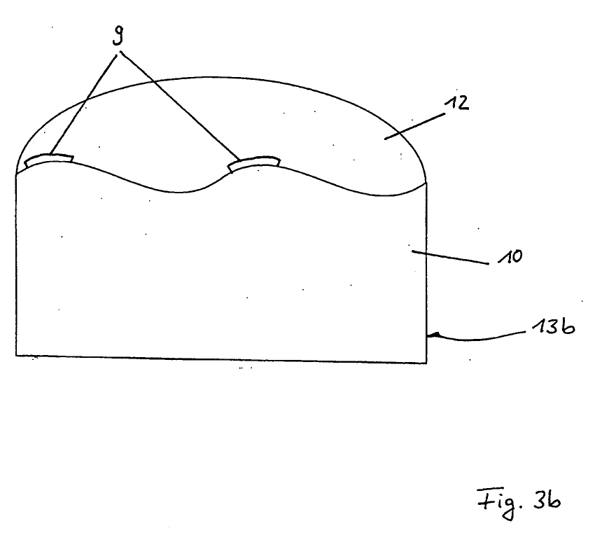

FIG. 3a shows a cross-section through a further decorated injection molded article having a three-dimensional structure in a surface region, and

FIG. 3b shows a cross-section through a further decorated injection molded article having a three-dimensional structure in a surface region, and which has a second plastic material injected thereover.

FIG. 1a shows a cross-section through a transfer film 1a in accordance with case a). The transfer film 1a has a carrier film 2 of PET with a layer thickness of 36 μm, a release layer 3 which is arranged on the carrier film 2 and which comprises a polyethylene wax with a melting range of 90-100° C. and a transfer layer 7 as a decorative element, arranged on the side of the release layer 3 remote from the carrier film 2, the decorative element having a plurality of layer portions. The transfer layer 7 has a protective lacquer layer 4 adjoining the release layer 3, a decorative layer 5 and, adjoining the decorative layer 5, on the side of the transfer film 1a that is remote from the carrier film 2, a priming layer 6 of polyvinyl chloride copolymers, polymethyl methacrylate (molecular weight 60,000 g/mol). A masking layer 8 partially covers the priming layer 6 on its side remote from the carrier film 2. The masking layer 8 is a highly cross-linked lacquer layer and has patterned openings 9a which partially expose the priming layer 6. A suitable lacquer for forming the masking layer 8 is of the following composition:

### EXAMPLE A

| | | |
|---|---|---|
| Acetone | 30 | parts |
| Butyl acetate | 5 | parts |
| Urethane acrylate (molecular weight about 1,600 g/mol) | 20 | parts |
| Trifunctional acrylic acid ester | 40 | parts |
| Photoinitiator type I | 5 | parts |

### EXAMPLE B

| | | |
|---|---|---|
| Ethanol | 10 | parts |
| Isopropanol | 8 | parts |
| Methyl ethyl ketone | 8 | parts |
| Toluene | 8 | parts |
| Hexamethylmethylmelamine | 25 | parts |
| Solution of a hydroxy-functionalized polymethyl | 31 | parts |
| metacrylate (60%) in xylene | | |
| Hydroxyfunctional polysiloxane | 3 | parts |
| p-Toluene sulfonic acid | 7 | parts |

The masking layer 8 can be used if PMMA, ABS, SAN, PS, PC, PP or suitable compatible mixtures of those materials is used as the plastic material.

FIG. 1b shows a cross-section through a transfer film 1b in accordance with case b). The transfer film 1b has a carrier film 2 of PET, a release layer 3 which is arranged on the carrier film 2 and which comprises a polyethylene wax (melting range of 80-100° C.) and a transfer layer as the decorative element, which is arranged on the side of the release layer 3 that is remote from the carrier film 2, the decorative element having a plurality of layer portions. The decorative element has a protective lacquer layer 4 adjoining the release layer 3, a colored decorative layer 5 and a priming layer 6 adjoining the decorative layer 5 on the side of the transfer film 1a that is remote from the carrier film 2. The priming layer 6 only partially covers the decorative layer 5. The colored decorative layer 5 was formed by means of the following composition:

Example for lacquer for forming the decorative layer 5

| | | |
|---|---|---|
| Methyl ethyl ketone | 63 | parts |
| Cyclohexanone | 5 | parts |
| Polymethyl metacrylate (molecular weight 100,000 g/mol) | 20 | parts |
| High-molecular dispersing additive | 3 | parts |
| Mica-based effect pigment | 9 | parts |

Example for primer 6

| | | |
|---|---|---|
| Acetone | 12 | parts |
| Toluene | 45 | parts |
| Chlorinated polyolefin (chlorine content 30%) | 33 | parts |
| Pyrogenic silicic acid | 10 | parts |

That decorative layer 5 can be used if PP, PE or TPO are used as the plastic materials.

FIG. 1c shows a cross-section through a transfer film 1c in accordance with case c). The transfer film 1c has a carrier film 2 of PET, a release layer 3 arranged on the carrier film 2 and a transfer layer as the decorative element 9, arranged on the side of the release layer 3 that is remote from the carrier film 2, the decorative element 9 having a plurality of layer portions. The decorative element 9 has adjoining the release layer 3 a protective lacquer layer 4, a decorative layer 5 and a priming layer 6 adjoining the decorative layer 5 on the side of the transfer film 1a that is remote from the carrier film 2. The decorative element 9 only partially covers the release layer 3, wherein the protective layer 4, the decorative layer 5 and the priming layer 6 are arranged in substantially coincident mutually superposed relationship.

The release layer 3 was formed by means of the following composition:

### EXAMPLE A

| | | |
|---|---|---|
| Ethanol | 10 | parts |
| Isopropanol | 8 | parts |
| Methyl ethyl ketone | 8 | parts |
| Toluene | 8 | parts |
| Hexamethylmethylmelamine | 25 | parts |
| Solution of a hydroxy-functionalized polymer | 29 | parts |
| methacrylate (60%) in xylene | | |
| Pyrogenic silicic acid | 5 | parts |
| p-Toluene sulfonic acid | 7 | parts |

### EXAMPLE B

| | | |
|---|---|---|
| Methyl ethyl ketone | 25 | parts |
| Ethyl acetate | 25 | parts |
| Cyclohexanone | 5 | parts |
| Polymethyl metacrylate (molecular weight 60,000 g/mol) | 18 | parts |
| Dipentaerithrolpentaacrylate | 25 | parts |
| Photoinitiator type I | 2 | parts |

This version functions for all thermoplastic polymers such as PMMA, ABS, ASA, PC, PP, PE, SAN, PVC and compatible mixtures thereof.

FIG. 2a shows a decorated injection molded article 11a as a cross-section. Decorative elements 9 are disposed partially on a surface of the hardened colored plastic material 10 of PMMA. The broken line denotes the position of an injection molded seam which is produced on the plastic material 10 in the seam region between the two halves of a closed, two-part injection molding mold.

FIG. 2b shows a cross-section of a decorated injection molded article 11b. Decorative elements 9 are disposed partially on a surface of the hardened colored plastic material 10 of PMMA. The broken line denotes the position of an injection molded seam which is produced on the plastic material 10 in the seam region between the two halves of a closed, two-part injection molding mold. The decorative elements 9 as well as the surface region of the plastic material 10, which is defined by the injection molded seam, has a second, colorlessly transparent plastic material 12 of PMMA or PC, PS, SAN or PA injected thereover, thus affording a depth effect.

FIG. 3a shows a cross-section of a decorated injection molded article 13a. Decorative elements 9 are disposed partially on a three-dimensionally structured surface of the hardened colored plastic material 10. In this respect the decorative elements 9 emphasize the raised portions in the hardened colored plastic material 10. The broken line denotes the position of an injection molded seam which is produced on the plastic material 10 in the seam region between the two halves of a closed, two-part injection molding mold.

FIG. 3b shows a cross-section of a decorated injection molded article 13b. Decorative elements 9 are disposed partially on a three-dimensionally structured surface of the hardened colored plastic material 10. In this respect the decorative elements 9 emphasize the raised portions in the hardened colored plastic material 10. The broken line denotes the position of an injection molded seam which is produced on the plastic material 10 in the seam region between the two halves of a closed, two-part injection molding mold. The decorative elements 9 as well as the surface region of the plastic material 10, which is delimited by the injection molded seam, has a second, colorlessly transparent plastic material 12 injected thereover, thereby giving a depth effect, with the three-dimensional structure of the hardened colored plastic material 10 remaining visible.

A large number of further possible design options for the decorated injection molded article will be readily apparent to the man skilled in the art.

1. A decorated injection molded article which is formed from at least one injected plastic material and at least one decorative element mechanically fixedly connected thereto, wherein the decorative element has one or more layer portions and provides a decoration and/or a protective layer for the injection molded article and wherein the injection molded article has at least one injection molded seam which is formed on the injected plastic material in the injection molding operation in the closing region of an injection molding mold in the transitional region between at least two individual parts of the injection molding mold, and wherein
the at least one decorative element only partially covers a surface region of the plastic material defined by an injection molded seam extending in an annular configuration on the plastic material and that the decorative element has at least one protective lacquer layer and/or at least one decorative layer and adjoining the protective lacquer or decorative layer at least one priming layer which softens at an injection molding temperature for the plastic material, wherein the priming layer is bonded to the plastic material.

2. A decorated injection molded article as set forth in claim 1, wherein at least two mutually independent decorative elements arranged in mutually juxtaposed relationship only partially cover the surface region of the plastic material, which is defined by the injection molded seam extending in an annular configuration on the plastic material.

3. A decorated injection molded article as set forth in claim 1, wherein the at least one decorative element is superimposed on a three-dimensional surface structuring of the plastic material.

4. A decorated injection molded article as set forth in claim 1, wherein the at least one decorative element on its side remote from the first plastic material is at least partially over-injected with a second plastic material.

5. A decorated injection molded article as set forth in claim 4, wherein, on its side remote from the at least one decorative element the second plastic material is at least partially covered with at least one further decorative element.

6. A transfer film for the production of a decorated injection molded article as set forth in claim 1, wherein the transfer film has at least a carrier film, a release layer arranged on the carrier film and a transfer layer means arranged on the side of the release layer remote from the carrier film, as a decorative element, wherein the decorative element has one or more layer portions and provides a decoration and/or a protective layer for the injection molded article, wherein the transfer layer means adjoining the release layer has at least one protective lacquer layer and/or at least one decorative layer and adjoining the protective lacquer or decorative layer on the side of the transfer film remote from the carrier film at least one priming layer which softens at an injection molding temperature and bonds to a plastic injection material to form the injection molded article, and wherein
a) a masking layer only partially covers the priming layer on its side remote from the carrier film, wherein the masking layer is such that it does not bond to the plastic material under injection conditions, or
b) the priming layer is only arranged region-wise and the protective lacquer or decorative layer adjoining the priming layer is such that it does not bond to the plastic material under injection conditions, or
c) the transfer layer is only arranged region-wise on the release layer and the release layer is such that it does not bond to the plastic material under injection conditions.

7. A transfer film as set forth in claim 6, wherein, in case a) the masking layer, in case b) the protective lacquer or decorative layer adjoining the priming layer and in case c) the release layer withstands an injection temperature for the plastic material without softening.

8. A transfer film as set forth in claim 6, wherein, in case a) the masking layer, in case b) the protective lacquer or decorative layer adjoining the priming layer and in case c) the release layer is chemically incompatible with the plastic material.

9. A transfer film as set forth in claim 6, wherein, in case a) the masking layer, in case b) the protective lacquer or decorative layer adjoining the priming layer and in case c) the release layer is a lacquer layer which is highly cross linked by radiation hardening, isocyanate hardening or acid hardening.

10. A transfer film as set forth in claim 6, wherein, in case a) the masking layer is of a thickness in the region of between 1 and 4 pm.

11. A transfer film as set forth in claim 6, wherein, in case (a) the masking layer has at least one opening, the opening being of a diameter of at least 0.15 mm.

12. A transfer film as set forth in claim 6, wherein, in case a) the masking layer, in case b) the priming layer and in case c) the transfer layer is patterned.

13. A transfer film as set forth in claim 6, wherein the decorative layer includes an at least partially formed metal layer and/or an at least partially formed interference layer and/or an at least partially formed color layer and/or an at least partially arranged layer with relief structures, diffractive structures or holograms, and/or a pigmented layer which has fluorescent or phosphorescent pigments or pigments with viewing angle-dependent color change effects.

14. A transfer film as set forth in claim 6, wherein the protective lacquer layer is colorlessly transparent, colored transparent or opaque.

15. A transfer film as set forth in claim 6, wherein the carrier film has a surface which forms the release layer.

16. A process for the production of a decorated injection molded article using a transfer film which has at least a carrier film, a release layer arranged on the carrier film and a transfer layer means arranged on the side of the release layer remote from the carrier film, as a decorative element, wherein the decorative element has one or more layer portions and provides a decoration and/or a protective layer for the injection molded article, wherein the transfer layer means adjoining the release layer has at least one protective lacquer layer and/or at least one decorative layer and adjoining the protective lacquer or decorative layer on the side of the transfer film remote from the carrier film at least one priming layer, wherein the transfer film is arranged in an opened injection molding mold comprising at least two individual parts, the injection molding mold is closed and filled with plastic injection material, wherein the priming layer softens at an injection temperature and bonds to the plastic injection material and wherein formed on the injection molded article is at least one injection molded seam which is formed in the closure region of the injection molding mold or in the transitional region between the at least two individual parts of the injection molding mold, and wherein the plastic injection material is hardened to provide a first plastic material, and wherein
the at least one decorative element is transferred onto a surface region of the plastic material defined by an injection molded seam extending in an annular configuration on the plastic material, in such a way that the at least one decorative element only partially covers the surface region.

17. A process as set forth in claim 16, wherein a transfer film is arranged in the injection molding mold in such a way that the carrier film bears directly against the injection molding mold.

18. A process as set forth in claim 16, wherein the injection molded article is lacquered at least in region-wise manner in a region which is free of the decorative element.

19. A process as set forth in claim 16, wherein a second plastic injection material is injected region-wise over the injection molded article.

20. A process as set forth in claim 16, wherein the injection molded article is glued, pressed or welded, preferably by means of laser radiation or ultrasound, to further structural units.

21. A process as set forth in claim 16, wherein the injection molded article is written upon in a region free of the decorative element.

22. A process as set forth in claim 16, wherein optical lens systems and/or contact surfaces of electrically conducting contact structures incorporated into the plastic material are arranged at a surface of the injection molded article.
